(19) United States
(12) Patent Application Publication
(10) Pub. No.: US 2022/0079332 A1
(43) Pub. Date: Mar. 17, 2022

(54) GAS SPRING SYSTEM FOR A HEIGHT ADJUSTABLE TABLE, HEIGHT ADJUSTABLE TABLE AND METHOD FOR OPERATING THE GAS SPRING SYSTEM

(71) Applicant: Kesseböhmer Holding KG, Bad Essen (DE)

(72) Inventors: Michael KÖDER, Plochingen (DE); Philipp STIEFELMAIER, Weilheim (DE); Arne SCHENKE, Esslingen (DE)

(73) Assignee: Kesseböhmer Holding KG, Bad Essen (DE)

(21) Appl. No.: 17/398,023

(22) Filed: Aug. 10, 2021

(30) Foreign Application Priority Data
Sep. 14, 2020 (DE) 10 2020 211 523.0

(51) Int. Cl. A47B 9/10; F16F 9/02

(52) U.S. Cl. CPC A47B 9/10; F16F 9/0227; F16F 2232/08; F16F 9/0263; F16F 9/0281

(57) ABSTRACT

A gas spring system (3) for a height adjustable table (1) comprises a gas spring (4) having a gas spring cylinder (6) with a gas compartment (9) provided therein, a gas spring piston (7) arranged therein and a gas spring piston rod (8) joined thereto. The gas spring system (3) further comprises a gas interface (10), connected to the gas compartment (9), which at least inserts gas from outside into the gas spring system (3), a transfer cylinder (12) having a transfer piston (13), a first transfer chamber (14) and a second transfer chamber (15) separated by the transfer piston (13), and a hydraulic pump (16). The gas comportment (9) is connected to the first transfer chamber (14) and the hydraulic pump (16) is connected to the second transfer chamber (15). The hydraulic pump (16) conveys hydraulic oil and the transfer piston (13) is moved in direction towards the first transfer chamber (14) by the hydraulic oil conveyed by the hydraulic pump (16) in order to increase a pressure in the first transfer chamber (14) and in the gas comportment (9).

### RELATED APPLICATION

This application claims the benefit of priority of Germany Patent Application No. 10 2020 211 523.0 filed on Sep. 14, 2020, the contents of which are incorporated herein by reference in their entirety.

### FIELD AND BACKGROUND OF THE INVENTION

The invention relates to a gas spring system for a height adjustable table, a height adjustable table and a method for operating the gas spring system, particularly for a table having varying loads.

Document WO 2014/183775 A1 describes an adjustable gas compression spring, a height adjustable column having a gas compression spring, and a furniture having the height adjustable column, wherein a gas compartment of the gas spring is connected to a gas storage. The volume of the gas storage can be varied via a piston shiftable by a translation screw, whereby the system pressure and, therefore, the lifting force of the gas spring can be changed. Upon an enduring change of a load on a tabletop, for example, by putting on or removing a printer or by attaching a screen wall, the lifting force of the gas spring can be adapted and an economic operation of the height adjustment can be realized again. The translation screw is driven either manually by means of a crank or, for example, by a cordless screwdriver.

However, an adjustment of the system pressure and, therefore, of the lifting force of the gas spring via a variation of the volume of the gas storage by means of a translation screw is elaborate and, particularly when using the cordless screwdriver, it is associated with an enormous amount of time if the cordless screwdriver is not immediately available.

Therefore, the object underlying the invention is to solve the above problem and to provide a gas spring system, a height adjustable table and a method for operating the gas spring system enabling a simple and quick adjustment of a force of a gas spring.

The object is achieved by a gas spring system according to claims 1, 5, 9 and 12, a height adjustable table according to claim 14 as well as by a method according to claims 15 and 17. Advantageous further developments are included in the dependent claims.

### SUMMARY OF THE INVENTION

According to an aspect of the invention, a gas spring system for a height adjustable table comprises a gas spring having a gas spring cylinder with a gas compartment provided therein, a gas spring piston arranged in the gas compartment and a gas spring piston rod joined with the gas spring piston. Further, the gas spring system comprises a gas interface connected to the gas compartment, wherein the gas interface is at least configured to insert gas from outside of the gas spring system into the gas spring system. Furthermore, the gas spring system comprises a transfer cylinder having a transfer piston, a first transfer chamber, and a second transfer chamber, wherein the first transfer chamber and the second transfer chamber are separated by the transfer piston and, moreover, it comprises a hydraulic pump, wherein the gas compartment of the gas spring is connected to the first transfer chamber, the hydraulic pump is connected to the second transfer chamber, the hydraulic pump is configured to convey hydraulic oil, and the transfer piston is configured to be moved in direction towards the first transfer chamber by the hydraulic oil conveyed by the hydraulic pump in order to increase a pressure in the first transfer chamber and the gas compartment of the gas spring.

Since an applied hydraulic all is incompressible, a volume of the first transfer chamber can precisely be changed by the usage of the transfer cylinder and the hydraulic pump and, thus, a pressure in the gas compartment in the gas spring cylinder can be quickly and exactly increased in order to thus increase a gas spring force. Since the pump enables a large conveying capacity, it is not necessary to apply a cordless screwdriver for enabling a quick adjustment of the gas spring force.

Via the gas interface connected to the gas compartment, it is possible to insert gas from outside into the gas spring system in order to, for example, preset the pressure in the gas compartment and, therefore, the gas spring force at delivery so that, e.g., an ergonomic height adjustment of the table upon a predefined load is possible.

In an advantageous implementation of the gas spring system, the hydraulic pump is configured to be operated by hand.

Upon an operation by hand, it's not necessary to make the efforts to provide a tool or, e.g., a cordless screwdriver for increasing the gas spring force and, thus, e.g., the lifting force of the gas spring after an increase of the load of the tabletop.

According to a further advantageous implementation of the gas spring system, the gas spring system further comprises a hydraulic oil check valve arranged between the hydraulic pump and the second transfer chamber and configured to prevent a flow of the hydraulic oil from the second transfer chamber towards the hydraulic pump and to enable a flow of the hydraulic oil from the hydraulic pump towards the second transfer chamber.

By the provision of the hydraulic oil check valve, oil can be conveyed from the hydraulic pump to the second transfer chamber, however, it is prevented that an oil pressure in the second transfer chamber and, therefore, a gas pressure in the first transfer chamber and in the gas compartment of the gas spring is reduced by a leakage in the hydraulic pump. The hydraulic oil check valve can either be included in a connection line between the hydraulic pump and the transfer cylinder or it can be integrated in the hydraulic pump.

In a further advantageous implementation of the gas spring system, the gas spring system comprises an oil reservoir and a hydraulic oil pressure drain valve, wherein the hydraulic oil pressure drain valve is configured to establish or separate a direct connection between the second transfer chamber and the oil reservoir.

By the provision of the hydraulic oil pressure drain valve, there is the option to reduce the oil pressure in the second transfer chamber and, therefore, the gas pressure in the first transfer chamber and in the gas compartment of the gas spring for, e.g., reducing the gas spring force, e.g., when the load of the tabletop is reduced. Since the oil reservoir is provided, it is possible to collect the surplus oil from the second transfer chamber and, as the case may be, to return it to the second transfer chamber when the load on the tabletop is later increased.

According to another aspect of the invention, a gas spring system comprises a gas spring having a gas spring cylinder with a gas compartment provided therein, a gas spring piston arranged in the gas compartment and a gas spring piston rod joined with the gas spring piston. Further, the gas spring system comprises a gas interface connected to the gas compartment of the gas spring, wherein the gas interface is at least configured to insert gas from outside of the gas spring system, a reciprocating pump connected to the gas compartment of the gas spring and configured to convey gas from the atmosphere to the gas compartment of the gas spring, wherein the reciprocating pump comprises a drive mechanism configured to function according to the principle of a toggle lever system.

By applying the drive mechanism according to the principle of a toggle lever system, it is possible to increase the gas pressure in the gas compartment of the gas spring by means of the reciprocating pump upon low effort and quickly. By the principle of a toggle lever system, a large stroke of a piston of the reciprocating pump from a posture of the reciprocating pump before a pump motion, therefore, a quick conveyance of a gas, can be enabled upon a relatively low effort. Further, the effort for the motion into a position of the piston of the reciprocating pump at the end of the pump motion at a built up high pressure can noticeably be reduced. Thus, an effective and rapid increase of the pressure in the gas compartment of the gas spring and, therefore, of the force of the gas spring is possible. Moreover, such an implementation enables a compact structure having few components.

Also according to this aspect, it is possible to insert gas from outside into the gas spring system via the gas interface connected to the gas compartment in order to pre-adjust, e.g., at delivery, the pressure in the gas compartment and, thus, the gas spring force in order to enable an ergonomic height adjustment of the table for a predefined load.

According to an advantageous implementation of the gas spring system, the reciprocating pump comprises a pump cylinder and a pump piston having a pump piston rod connected to this and being movable in a predetermined direction. Further, the drive mechanism comprises a first support device movable relatively to the pump cylinder in the predetermined direction, wherein the pump piston rod is joined with the first support device, a second support device fixed with respect to the pump cylinder, a first lever joined in an articulated manner with the first support device, a second lever respectively joined in an articulated manner with the second support device and the first lever for forming the drive device according to the principle of a toggle lever system.

By this arrangement, a design of the drive according to the principle of a toggle lever system as simple as possible is possible.

According to a further advantageous implementation of the gas spring system, the gas spring system further comprises a pump check valve configured to prevent a flow of the gas from the gas compartment of the gas spring towards the reciprocating pump and to enable a flow of the gas from the reciprocating pump towards the gas compartment of the gas spring.

By the provision of the pump check valve, the gas can be conveyed from the reciprocating pump towards the gas compartment of the gas spring, however, it is prevented that the gas pressure in the gas compartment reduces due to a leakage in the reciprocating pump.

The pump check valve can either be included in a connection line between the reciprocating pump and the gas spring or it can be integrated in the reciprocating pump.

In a further advantageous implementation of the gas spring system, the gas spring system further comprises a venting valve provided in a line between the reciprocating pump and the gas compartment of the gas spring and which is configured to the exhaust gas from the gas spring system.

By the provision of the venting valve, there is the option to reduce the gas pressure in the gas compartment of the gas spring for reducing the gas spring force, e.g., when a load on the tabletop is reduced.

According to another aspect of the invention, the gas spring system comprises a gas spring having a gas spring cylinder with a gas compartment provided therein, a gas spring piston arranged in the gas compartment and a gas spring piston rod joined with the gas spring piston, as well as a reciprocating pump connected to the gas compartment of the gas spring and configured to convey gas into the gas compartment of the gas spring. The reciprocating pump comprises a first pump gas compartment connected to the gas compartment of the gas spring, a pump piston, a second pump gas compartment separated from the first pump gas compartment by the pump piston, a pump check valve configured to prevent a flow of the gas from the gas compartment towards the first pump gas compartment and to enable a flow of the gas from the first pump gas compartment towards the gas compartment, a piston check valve configured to be movable with the pump piston and to prevent a flow of the gas from the first pump gas compartment to the second pump gas compartment and to enable a flow of the gas from the second pump gas compartment towards the first pump gas compartment, and an inlet check valve configured to prevent a flow of the gas out of the second pump gas compartment and to enable a flow of the gas into the second pump gas compartment. Further, the gas spring system comprises a second gas storage connected to the inlet check valve, a gas drain valve which is, on the one side, connected to the gas compartment of the gas spring and, on the other side, connected to the inlet check valve and the second gas storage, and a gas interface connected to the second gas storage, wherein the gas interface is at least configured to insert gas from outside of the gas spring system into the gas spring system.

By the connection of the second gas storage and the insert check valve of the reciprocating pump, an operating force to be applied manually onto the piston of the reciprocating pump is reduced and, thus, pumping of the gas towards the gas compartment of the gas spring 4 increasing the pressure in the gas compartment and, thus, the gas spring force, is facilitated. Further, the quantity of the necessary pump strokes is remarkably reduced with respect to a filling out of the atmosphere.

The gas drain valve with its connections enables to reduce the pressure in the gas compartment of the gas spring for reducing the gas spring force, e.g., when the load on the tabletop is reduced, wherein, however, the gas is not exhausted into the environment but to the second gas storage in order to be available upon a subsequent necessary increase of the pressure in the gas compartment of the gas spring.

Due to the provision of the pump check valve, the gas can be conveyed from the reciprocating pump to the gas compartment of the gas spring, however, it is prevented that the gas pressure in the gas compartment reduces due to a leakage in the reciprocating pump. The pump check valve can either be included in a connection line between the reciprocating pump and the gas compartment of the gas spring or it can be integrated in the reciprocating pump.

In an advantages implementation of the gas spring system, it comprises a first gas storage connected to the gas compartment of the gas spring.

By the first gas storage, a gas volume of the gas spring system on the side of the gas compartment of the gas spring is enlarged in order to flatten a spring characteristic of the gas spring so that the lifting force of the gas spring across its entire adjustment range remains as constant as possible.

According to a further advantageous implementation of the gas spring system, it comprises a first pressure display device connected to the gas compartment of the gas spring.

By the provision of the first pressure display device, the actual filling pressure of the gas compartment of the gas spring can be monitored. Upon an appropriate calibration, it is also possible to directly read off a lifting force of the gas spring.

According to a further aspect of the invention, a gas spring system comprises a gas spring having a gas spring cylinder with a gas compartment provided therein, a gas spring piston arranged in the gas compartment, and a gas spring piston rod joined with the gas spring piston, wherein the gas spring system further comprises a gas interface connected to the gas compartment and a filling cartridge, having an unchangeable gas volume, which can be connected to the gas interface.

By this gas spring system, in particular, when the filling cartridge is filled with a high pressure gas, the gas compartment of the gas spring can easily and rapidly be filled by connecting the filling cartridge to the gas interface.

In an advantageous implementation of the gas spring system, it further comprises a connection block which can be connected, on the one side, with the gas interface and, on the other side, with the filling cartridge, wherein the connection block comprises at least one of a cut-off valve, a pressure regulator or limiter and a second pressure display device.

The provision of the connection block enables a comfortable and safe operation of the gas spring system when changing the gas spring force.

According to a further aspect of the invention, a height adjustable table is provided with a spring system.

With such a table, it is possible to perform an adaption of the lifting force rapidly and without large effort.

According to a further aspect of the invention, a method for operating a gas spring system comprises the step: pumping the hydraulic oil by means of the hydraulic pump into the second transfer chamber so that the transfer piston is moved in a direction towards the first transfer chamber and increases the pressure in the first transfer chamber for increasing a force of the gas spring.

Since a utilized hydraulic oil is incompressible, by the utilization of the transfer cylinder and the hydraulic pump, a volume of the first transfer chamber can be changed precisely and, thus, a pressure in the gas compartment in the gas spring cylinder can be quickly and exactly increased in order to increase the pressure in the gas compartment and, thus, the gas spring force. Since the pump enables a large conveying amount, it is not necessary to employ a cordless screwdriver in order to the enable a rapid adjustment of the gas spring force.

In an advantageous implementation of the method, it comprises the step: opening the hydraulic oil pressure drain valve for establishing a connection between the second transfer chamber and the oil reservoir and for reducing an oil pressure in the second transfer chamber so that the transfer piston is moved in a direction towards the second transfer chamber and the pressure in the first transfer chamber is reduced for reducing a force of the gas spring.

By opening the hydraulic oil pressure drain valve, there is the possibility to easily reduce the oil pressure in the second transfer chamber and, thus, the gas pressure in the first transfer chamber and in the gas compartment of the gas spring in order to reduce the gas spring force, e.g., when the load on the tabletop is reduced. Since the oil reservoir is provided, it is possible to collect the surplus oil from the second transfer chamber and, as the case may be, to return it to the second transfer chamber upon a later increase of the load on the tabletop.

According to another aspect of the invention, the method comprises the steps: pumping gas from the second gas storage to the gas compartment of the gas spring for increasing a force of the gas spring, and exhausting the gas from the gas compartment of the gas spring to the second gas storage by means of the gas drain valve for reducing the force of the gas spring.

By pumping the gas from the second gas storage, an operating force onto the piston of the reciprocating pump to be applied manually is reduced and, thus, the pumping of the gas towards the gas compartment of the gas spring for increasing the pressure in the gas compartment and, thus, the gas spring force is facilitated. Further, the quantity of the necessary pump strokes is noticeably reduced compared to a filling from the atmosphere. Moreover, the pressure in the gas compartment of the gas spring can be reduced for reducing the gas spring force, e.g., when the load on the tabletop is reduced, wherein the gas is not exhausted to the environment but to the second gas storage in order to be available again for a subsequent necessary increase of the pressure in the gas compartment of the gas spring.

### BRIEF DESCRIPTION OF THE SEVERAL VIEWS OF THE DRAWINGS

Below, the invention is elucidated by means of embodiments referring to the attached drawings.

In particular,

FIG. 1 shows a height adjustable table having a gas spring system according to the invention;

FIG. 2 shows a schematic illustration of a first embodiment of the gas spring system;

FIG. 3 shows a schematic illustration of a second embodiment of the gas spring system;

FIG. 4 shows a schematic illustration of a third embodiment of the gas spring system; and

FIG. 5 shows a schematic illustration of a fourth embodiment of the gas spring system.

### DESCRIPTION OF SPECIFIC EMBODIMENTS OF THE INVENTION

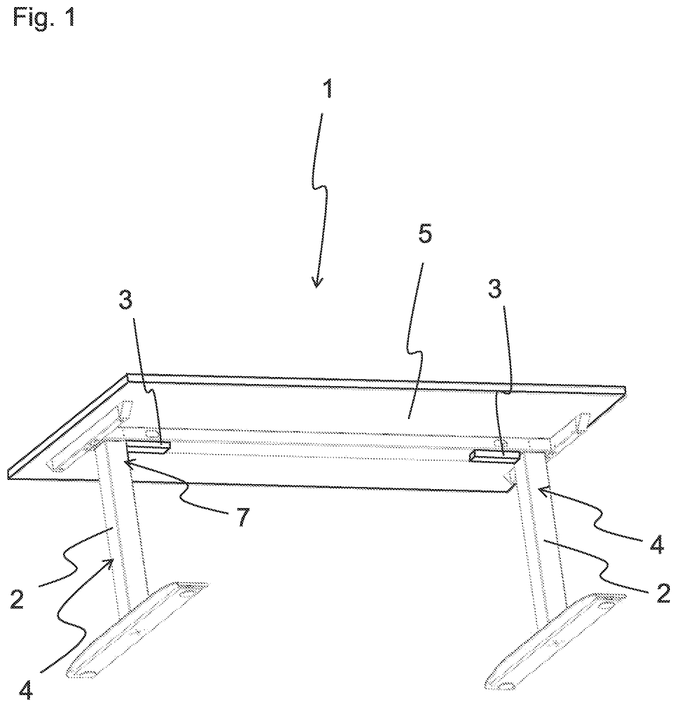

FIG. 1 shows an adjustable table 1 having two height adjustable columns 2 as table legs respectively provided with a gas spring system 3. The gas spring systems 3 respectively comprise a gas spring 4 inside the two height adjustable columns 2 for adjusting a length of the height adjustable columns 2. Further, the height adjustable table 1 comprises a tabletop 5 which is height adjustable by means of the two height adjustable columns 2.

Alternatively, the table 1 does not comprise two height adjustable columns 2 but either only one height adjustable column 2 or more than two height adjustable columns 2. Further alternatively, the gas spring system 3 is not provided in a height adjustable table 1 but in another furniture having a force assisted adjustable component. The gas spring in this application is configured as a compression gas spring, however, it can alternatively also be configured as a tensile gas spring.

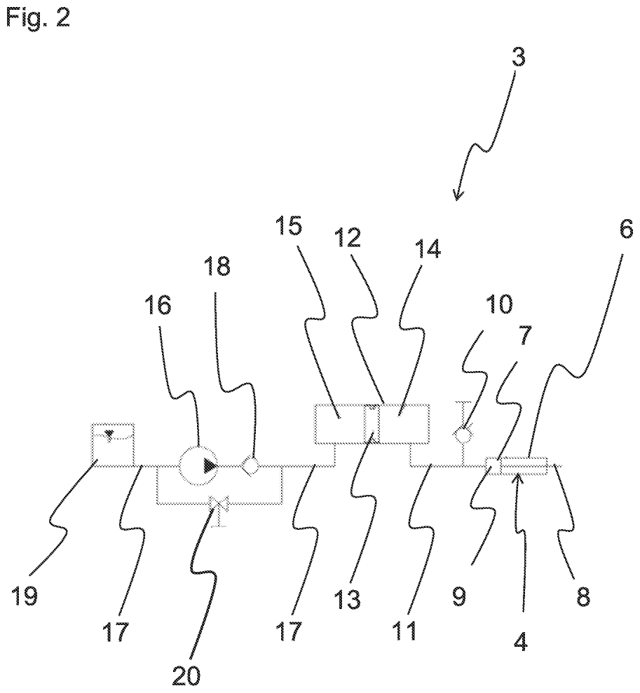

FIG. 2 shows a schematic illustration of a first embodiment of the gas spring system 3.

The gas spring 4 comprises a gas spring cylinder 6 and a gas spring piston 7 arranged in the gas spring cylinder 6. The gas spring piston 7 is joined with a gas spring piston rod 8 and limits a gas compartment 9 in the gas spring cylinder 6.

The gas spring system 3 comprises a gas interface 10 connected to the gas compartment 9 of the gas spring 4 and being at least configured to insert gas from outside of the gas spring system 3 into the gas spring system 3. The gas interface 10 is directly connected to the gas compartment 9 via a gas line 11. Alternatively, the gas interface 10 can also be integrated in the gas spring 4 such that it is connected to the gas compartment 9 of the gas spring 4. In FIG. 2, the gas interface 10 is illustrated as a check valve. Alternatively, it is also possible that, e.g., a cutoff valve is provided as the gas interface 10.

Further, the gas spring system 3 comprises a transfer cylinder 12 in order to transfer an oil pressure to a gas pressure. The transfer cylinder 12 comprises a transfer piston 13, a first transfer chamber 14 and a second transfer chamber 15. The first transfer chamber 14 and the second transfer chamber 15 are separated by the transfer piston 13.

Moreover, the gas spring system 3 comprises a hydraulic pump 16 configured to convey a hydraulic oil. The hydraulic pump 16 is configured to be operated by hand via a crank. Alternatively, there is the option to operate the hydraulic pump by hand by means of a lever or by means of a motor.

The gas compartment 9 of the gas spring 4 is connected to the first transfer chamber 14 by means of the gas line 11. Alternatively, the transfer cylinder 12 and the gas spring 4 can be formed integrally. The hydraulic pump 16 is connected to the second transfer chamber 15 by means of an oil line 17. The transfer piston 13 is configured to be moved by the hydraulic oil conveyed by the hydraulic pump 16 in direction towards the first transfer chamber 14 so that the transfer piston 13 transfers the pressure of the hydraulic oil into the pressure of a gas in order to increase a pressure in the first transfer chamber 14 and the gas compartment 9 of the gas spring 4 in order to thus set a higher gas spring force.

The gas spring system 3 further comprises a hydraulic oil check valve 18 which is arranged in the oil line 17 between the hydraulic pump 16 and the second transfer chamber 15. The hydraulic oil check valve 18 is configured to prevent a flow of the hydraulic oil from the second transfer chamber 15 toward the hydraulic pump 16 and to enable a flow of the hydraulic oil from the hydraulic pump 16 towards the second transfer chamber 15. Alternatively, the hydraulic oil check valve 18 can also be integrated either in the transfer cylinder 12 or in the hydraulic pump 16, or, particularly in the case of a reliably tight hydraulic pump 16, it can be omitted.

Finally, the gas spring system 3 comprises an oil reservoir 19 and a hydraulic oil pressure drain valve 20. The oil reservoir 19 is filled with the hydraulic oil in order to be provided for the hydraulic pump 16 via the oil line 17. The hydraulic oil pressure drain valve 20 is connected to the oil line 17 such that it bypasses the hydraulic pump 16 and the hydraulic oil check valve 18. Thus, the hydraulic oil pressure drain valve 20 is able to establish or shut off a direct connection between the second transfer chamber 15 and the reservoir 19.

In this embodiment, the gas spring system 3 is illustrated in the manner that an own transfer cylinder 12 and an own hydraulic pump 16 is provided for each gas spring 4. In alternative embodiments, the oil reservoir 19 and/or of the hydraulic pump 16 and/or the transfer cylinder 15 are provided for several gas springs 4.

In use, the gas spring system 3 is filled with gas having a necessary pressure for an economic height adjustment, e.g., at delivery or during installation of the height adjustable table 1. In a case in which an additional load is enduringly applied onto the tabletop 5, for example by putting on a printer or a screen wall, the lifting force of the gas spring 4 can be adapted by pumping hydraulic oil from the oil reservoir 19 into the second transfer chamber 15 by means of the hydraulic pump 16 operated by hand. Since the hydraulic oil is incompressible, the transfer piston 13 is moved in direction towards the first transfer chamber 14 so that the pressure in the first transfer chamber 14 and the gas filled compartment 9 of the gas spring 4 increases in order to increase the force of the gas spring 4. This force is transmitted to the height adjustable column 2 via the gas spring piston 7 and the gas spring piston rod 8.

For reducing the force of the gas spring 4, the hydraulic oil pressure drain valve 20 is opened in order to establish a connection between the second transfer chamber 15 and the oil reservoir 19 and to reduce an oil pressure in the second transfer chamber 15 so that the transfer piston 13 is moved in direction towards the second transfer chamber 15 and the pressure in the first transfer chamber 14 and in the gas compartment 9 of the gas spring 4 is reduced.

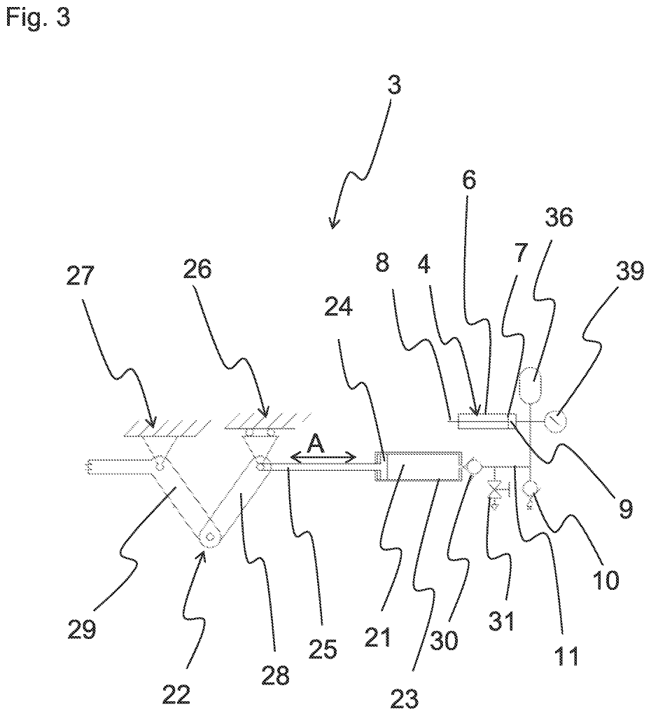

FIG. 3 shows a schematic illustration of a second embodiment of the gas spring system 3.

Analogously to the first embodiment, the gas spring system 3 comprises the gas spring 4 having all of its above described components and the gas interface 10.

However, instead of a hydraulic operating system, a reciprocating pump 21 connected to the gas compartment 9 of the gas spring 4 and being configured to convey the gas to the gas compartment 9 of the gas spring 4 is provided in the second embodiment. The reciprocating pump 21 comprises a drive mechanism 22 which is configured to function according to the principle of a toggle lever system.

Thereto, the reciprocating pump 21 comprises a pump cylinder 23 and a pump piston 24 having a pump piston rod 25 joined to this and being movable in a reciprocating manner in a predetermined direction A. The drive device 22 comprises a first support device 26 movable relatively to the pump cylinder 23 in the predetermined direction A. The pump piston rod 25 is joined with the first support device 26. Further, the drive device 22 comprises a second support device 27 being fixed relatively to the pump cylinder 23. Finally, the drive device 22 comprises a first lever 28 joined in an articulated manner with the first support device 26 and a second lever 29 respectively joined in an articulated manner with the second support device 27 and the first lever 28 in order to form the drive mechanism 22 according to the principle of a toggle lever system. In alternative embodiments, the reciprocating pump 21 can be formed as a multiplunger pump and/or as a double-acting pump.

The gas spring system 3 further comprises a pump check valve 30 configured to prevent a flow of the gas from the gas compartment 9 of the gas spring 4 towards the reciprocating pump 21 and to enable a flow of the gas from the reciprocating pump 21 towards the gas compartment 9 of the gas spring 4. The pump check valve 30 is provided in the gas line 11 between the reciprocating pump 21 and the gas compartment 9 of the gas spring 4. Alternatively, the pump check valve 30 can also be integrated in the reciprocating pump 21 or in the gas spring 4 or, particularly in the case of a reliably tight reciprocating pump 21, it can be omitted.

Finally, the gas spring system 3 according to the second embodiment comprises a venting valve 31 provided in the line 11 between the reciprocating pump 21 and the gas compartment 9 of the gas spring 4. The venting valve 31 is configured to exhaust gas from the gas spring system 3. In alternative embodiments, the venting valve can be provided on the gas spring 4 or on the reciprocating pump 21 and, particularly when the gas interface 10 is formed a stop-cock, a separate venting valve 31 can be omitted.

The gas spring system 3 according to the second embodiment further comprises a first gas storage 36 and a first pressure display device 39 which are connected to the gas compartment 9 of the gas spring 4. In alternative embodiments of the gas spring system 3 either none or only one of the first gas storage 36 and the first pressure display device 39 is provided.

In use, the gas spring system 3 is prefilled with the pressure necessary for an ergonomic height adjustment of the tabletop 5 via the gas interface 10. In a case, in which an additional load is enduringly applied onto the tabletop 5, for example, by putting on a printer or a screen wall, the lifting force of the gas spring 4 can be adapted by pumping air from the environment as the gas into the gas spring system 3 by means of the reciprocating pump 21 operated by the toggling lever system. For reducing the pressure, the gas can be exhausted into the environment via the venting valve 31.

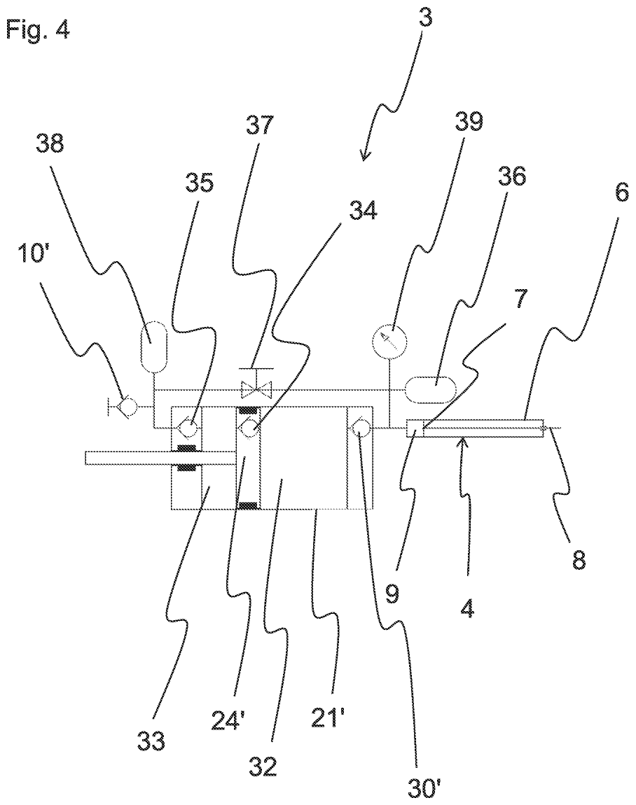

FIG. 4 shows a schematic illustration of a third embodiment of the gas spring system 3.

As in the first and second embodiment, the gas spring system 3 according to the third embodiment comprises the gas spring 4 having the above described components.

The gas spring system 3 according to the third embodiment further comprises a reciprocating pump 21′ connected to the gas compartment 9 of the gas spring 4 and configured to convey gas to the gas compartment 9 of the gas spring 4. Thereto, the reciprocating pump 21′ comprises a first pump gas compartment 32 connected to the gas compartment 9 of the gas spring 4, a pump piston 24′ and a second pump gas compartment 33 which is separated from the first pump gas compartment 32 by the pump piston 24′. Further, the reciprocating pump 21′ comprises a pump check valve 30′ configured to prevent a flow of the gas from the gas compartment 9 of the gas spring 4 towards the first pump gas compartment 32 and to enable a flow of the gas from the first pump gas compartment 32 toward the gas compartment 9 of the gas spring 4. Except from that, the reciprocating pump 21′ comprises a piston check valve 34 configured to be movable with the pump piston 24′ and to prevent a flow of the gas from the first pump gas compartment 32 to the second pump gas compartment 33 and to enable a flow of the gas from the second pump gas compartment 33 towards the first pump gas compartment 32. Finally, the reciprocating pump 21′ comprises an inlet check valve 35 configured to prevent a flow of the gas out of the second pump gas compartment 33 and to enable a flow of the gas into the second pump gas compartment 33.

In the third embodiment, the gas spring system 3 comprises a second gas storage 38 which is connected to the inlet check valve 35, a gas drain valve 37 which is, on the one side, connected to the gas compartment 9 of the gas spring 4 and, on the other side, to the inlet check valve 35 and the second gas storage 38, and a gas interface 10′ connected to the second gas storage 38, wherein the gas interface 10′ is at least configured to insert gas from outside of the gas spring system 3 into the gas spring system 3.

The gas spring system 3 according to the third embodiment further also comprises the first gas storage 36 and the first pressure display device 39 which are connected to the gas compartment 9 of the gas spring 4. In alternative embodiments of the gas spring system 3, either none or only one of the first gas storage 36 and the first pressure display device 39 is provided.

The reciprocating pump 21′ of the third embodiment of the gas spring system 3 is operated by means of the drive device according to the principle of a toggle lever system. Alternatively, a pump piston rod 25′ can also be directly operated, e.g., by hand. In alternative embodiments, the reciprocating pump 21′ can be designed as a multiplunger pump and/or as a double-acting pump. The reciprocating pump 21′ of the third embodiment of the gas spring system 3 can also be employed as an alternative embodiment of the reciprocating pump 21 of the second embodiment of the gas spring system 3.

In use, the gas spring system 3 is prefilled with the pressure necessary for an ergonomic height adjustment of the tabletop 5 via the gas interface 10′. In a case in which an additional load onto the tabletop 5 is enduringly applied, e.g., by putting on a printer or a screen wall, the lifting force of the gas spring 4 can be increased by pumping gas out of the second storage 38 to the gas compartment 9 of the gas spring 4 by means of the reciprocating pump 21′. For reducing pressure and, thus, for reducing the force of the gas spring, the gas can be exhausted back into the second storage 38 via the gas drain valve 37.

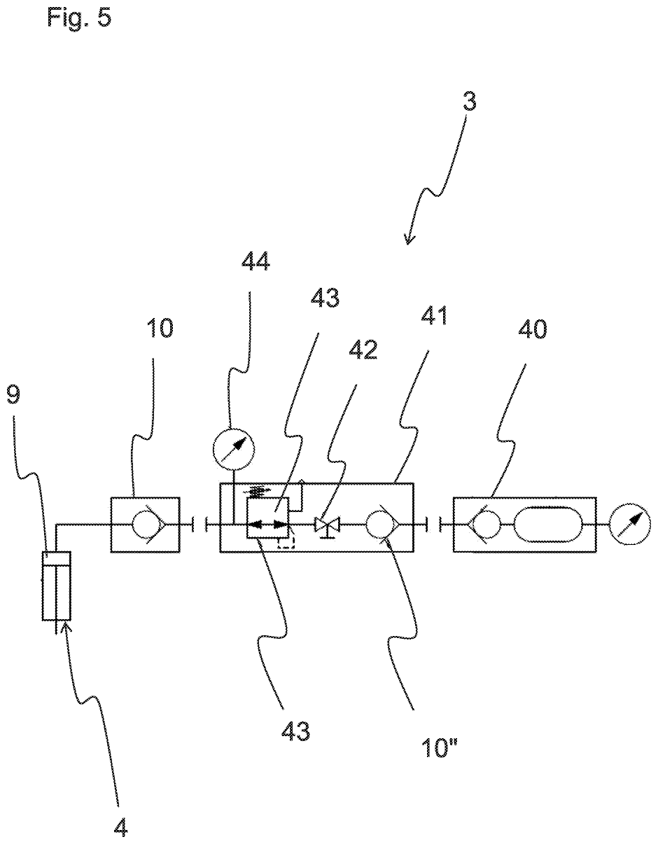

FIG. 5 shows a schematic illustration of a fourth embodiment of the gas spring system 3.

The gas spring system 3 according to the fourth embodiment distinguishes from the gas spring systems 3 according to the first to third embodiment in that that no pump for increasing the pressure in the gas compartment 9 of the gas spring 4 but a filling cartridge 40 is provided. The filling cartridge 40 can be connected to the gas interface 10, nevertheless, it also can be detached. The filling cartridge 40 has a fixed, in particular, cylindrical shape and, thus, an unchangeable gas volume and is filled with air, nitrogen or carbon dioxide with a filling pressure of up to 200 bar. Optionally, the filling cartridge 40 is provided with a manometer. In the embodiment shown in FIG. 5, the gas spring system 3 further comprises a connection block 41 which can be connected, on the one side, with the gas interface 10 and, on the other side, with the filling cartridge 40. Thus, the filling cartridge 40 can be connected to the gas compartment 9 of the gas spring 4 via the connection block 41. The connection block 41 is provided with a cut-off valve 42, a pressure regulator or limiter 43 and a second pressure display device 44. In an alternative embodiment, the gas spring system 3 is not provided with the connection block 41 and the filling cartridge 40 is directly connected to the gas interface. Further, the connection block 41 comprises a further gas interface 10″ which is, formed as a check valve, connectable to the filling cartridge 40. In further alternative embodiments, the cutoff valve 42 and/or the pressure regulator or limiter 43 and/or the second pressure display device 44 are not provided. Moreover, in further alternative embodiments, the connection block 41 is either integrated in the filling cartridge 40 or in the gas spring 4.

In use, the filling cartridge 40, as the case may be, via the connection block 41, is connected to the gas interface 10 and, thereby, either automatically or after opening of the cutoff valve 42, the gas included in the filling cartridge 40 at high pressure is guided into the gas compartment 9 of the gas spring 4 so that the pressure in the gas compartment 9 of the gas spring 4 increases to an appropriate value.

If it is necessary to reduce the pressure in the gas compartment 9 of the gas spring 4 since, for example, the load on the tabletop 5 has decreased, the pressure is reduced by means of the pressure regulator or limiter 43 or, if the connection block is not provided, at the gas interface 10 by means of an auxiliary tool.

All features illustrated in the description, the subsequent claims, and the drawings can be solitarily as well as in an arbitrary combination relevant for the invention.

What is claimed is:

1. Gas spring system (3) for a height adjustable table (1) comprising
a gas spring (4) having
a gas spring cylinder (6) with a gas compartment (9) provided therein,
a gas spring piston (7) arranged in the gas compartment (9), and
a gas spring piston rod (8) joined with the gas spring piston (7),
characterized in that
the gas spring system (3) further comprises:
a gas interface (10) connected to the gas compartment (9), wherein the gas interface (10) is at least configured to insert gas from outside of the gas spring system (3) into the gas spring system (3),
a transfer cylinder (12) having an transfer piston (13), a first transfer chamber, (14) and a second transfer chamber (15), wherein the first transfer chamber (14) and the second transfer chamber (15) are separated by the transfer piston (13), and
a hydraulic pump (16),
wherein
the gas compartment (9) of the gas spring (4) is connected to the first transfer chamber (14),
the hydraulic pump (16) is connected to the second transfer chamber (15),
the hydraulic pump (16) is configured to convey hydraulic oil, and
the transfer piston (13) is configured to be moved by the hydraulic oil conveyed by the hydraulic pump (16) in direction towards the first transfer chamber (14) in order to increase a pressure in the first transfer chamber (14) and the gas compartment (9) of the gas spring (4).

2. Gas spring system (3) according to claim 1, wherein
the hydraulic pump (16) is configured to be operated by hand.

3. Gas spring system (3) according to claim 1, wherein
the gas spring system (3) further comprises a hydraulic oil check valve (18) arranged between the hydraulic pump (16) and the second transfer chamber (15) and configured to prevent a flow of the hydraulic oil from the second transfer chamber (15) towards the hydraulic pump (16) and to enable a flow of the hydraulic oil from the hydraulic pump (16) towards the second transfer chamber (15).

4. Gas spring system (3) according to claim 1, wherein
the gas spring system (3) comprises an oil reservoir (19) and a hydraulic oil pressure drain valve (20), wherein
the hydraulic oil pressure drain valve (20) is configured to establish or shut off a direct connection between the second transfer chamber (15) and the oil reservoir (19).

5. Gas spring system (3) comprising
a gas spring (4) having
a gas spring cylinder (6) with a gas compartment (9) provided therein,
a gas spring piston (7) arranged in the gas compartment (9), and
a gas spring piston rod (8) joined with the gas spring piston (7),
characterized in that
the gas spring system (3) further comprises:
a gas interface (10) connected to the gas compartment (9) of the gas spring (4), wherein the gas interface (10) is at least configured to insert gas from outside of the gas spring system (3) into the gas spring system (3),
a reciprocating pump (21) connected to the gas compartment (9) of the gas spring (4) and which is adapted to convey gas towards the gas compartment (9) of the gas spring (4), wherein
the reciprocating pump (21) comprises a drive mechanism (22) configured to function according to the principle of a toggle lever system.

6. Gas spring system (3) according to claim 5, wherein
the reciprocating pump (21) comprises a pump cylinder (23) and a pump piston (24) with a pump piston rod (25) connected with this and movable in a predetermined direction, and
the drive mechanism (22) comprises:
a first support device (26) movable in the predetermined direction relatively to the pump cylinder (23), wherein the pump piston rod (25) is joined with the first support device (26),
a second support device (27) fixed relatively to the pump cylinder (23),
a first lever (28) joined in an articulated manner with the first support device (26), and
a second lever (29) joined in an articulated manner respectively with the second support device (27) and the first lever (28) in order to form the drive mechanism (22) according to the principle of a toggle lever system.

7. Gas spring system (3) according to claim 5, wherein
the gas spring system (3) further comprises a pump check valve (30) configured to prevent a flow of the gas from the gas compartment (9) of the gas spring (4) towards the reciprocating pump (21) and to enable a flow of the gas from the reciprocating pump (21) towards the gas compartment (9) of the gas spring (4).

8. Gas spring system (3) according to claim 5, wherein
the gas spring system (3) further comprises a venting valve (31) provided between the reciprocating pump (21) and the gas compartment (9) of the gas spring (4) and configured to the exhaust gas out of the gas spring system (3).

9. Gas spring system (3) comprising
a gas spring (4) having
a gas spring cylinder (6) with a gas compartment (9) provided therein,
a gas spring piston (7) arranged in the gas compartment (9), and
a gas spring piston rod (8) joined with the gas spring piston (7), wherein the gas spring system (3) further comprises:
a reciprocating pump (21′) connected to the gas compartment (9) of the gas spring (4) and configured to convey gas to the gas compartment (9) of the gas spring (4),
characterized in that
the reciprocating pump (21′) comprises:
a first pump gas compartment (32) connected to the gas compartment (9) of the gas spring (4),
a pump piston (24′),
a second pump gas compartment (33) separated from the first pump gas compartment (32) by the pump piston (24′),
a pump check valve (30′) configured to prevent a flow of the gas from the gas compartment (9) of the gas spring (4) towards the first pump gas compartment (32) and to enable a flow of the gas from the first pump gas compartment (32) towards the gas compartment (9) of the gas spring (4),
a piston check valve (34) configured to be movable with the pump piston (24′) and to prevent a flow of the gas from the first pump gas compartment (32) towards the second pump gas compartment (33) and to enable a flow of the gas from the second pump gas compartment (33) towards the first pump gas compartment (32),
an inlet check valve (35) configured to prevent a flow of the gas out of the second pump gas comportment (33) and to enable a flow of the gas into the second pump gas compartment (33), wherein
the gas spring system (3) further comprises:
a second gas storage (38) connected to the insert check valve (35),
a gas drain valve (37) connected, on the one side, with the gas compartment (9) of the gas spring (4) and, on the other side, with the insert check valve (35) and the second gas storage (38), and
a gas interface (10′) connected to the second gas storage (38), wherein the gas interface (10′) is at least configured to insert gas from outside of the gas spring system (3) into the gas spring system (3).

10. Gas spring system (3) according to claim 5, wherein
the gas spring system (3) comprises a first gas storage (36) connected to the gas compartment (9) of the gas spring (4).

11. Gas spring system (3) according to claim 5, wherein
the gas spring system (3) comprises a first pressure display device (39) connected to the gas compartment (9) of the gas spring (4).

12. Gas spring system (3) comprising
a gas spring (4) having
a gas spring cylinder (6) with a gas compartment (9) provided therein,
a gas spring piston (7) provided in the gas compartment (9), and
a gas spring piston rod (8) joined with the gas spring piston (7),
wherein
the gas spring system (3) further comprises:
a gas interface (10) connected to the gas compartment (9), and
a filling cartridge (40), having an unchangeable gas volume, connectable to the gas interface (10).

13. Gas spring system (3) according to claim 12, wherein
the gas spring system (3) further comprises a connection block (41) connectable, on the one side, with the gas interface (10) and, on the other side, with the filling cartridge (40), wherein the connection block (41) comprises at least one of a cutoff valve (42), a pressure regulator or a limiter (43) and a second pressure display device (44).

14. Height adjustable table (1) having a gas spring system (3) according to claim 1.

15. Method for operating a gas spring system (3) according to claim 1 having the step:
pumping the hydraulic oil by means of the hydraulic pump (16) into the second transfer chamber (15) so that the transfer piston (13) is moved in direction towards the first transfer chamber (14) and increases the pressure in the first transfer chamber (14) in order to increase a force of the gas spring (4).

16. Method according to claim 15, having the step:
opening a hydraulic oil pressure drain valve (20) in order to establish a connection between a second transfer chamber (15) and an oil reservoir (19) and to reduce an oil pressure in the second transfer chamber (15) so that the transfer piston (13) is moved in direction towards the second transfer chamber (15) and the pressure in the first transfer chamber (14) is reduced in order to reduce a force of the gas spring (4).

17. Method for operating a gas spring system (3) according to claim 9, having the steps:
pumping gas from the second gas storage (38) to the gas compartment (9) of the gas spring (4) for increasing a force of the gas spring (4); and
exhausting the gas out of the gas compartment (9) of the gas spring (4) by means of the gas drain valve (37) to the second gas storage (38) for reducing the force of the gas spring (4).
